(19) United States
(12) Patent Application Publication
(10) Pub. No.: US 2025/0088966 A1
(43) Pub. Date: Mar. 13, 2025

(54) Downlink Control Information-Based Low Power Wake-Up Signal Monitoring

(71) Applicant: Qualcomm Incorporated, San Diego, CA (US)

(72) Inventors: Ahmed ELSHAFIE, San Diego, CA (US); Yuchul KIM, San Diego, CA (US); Linhai HE, San Diego, CA (US); Wei YANG, San Diego, CA (US)

(21) Appl. No.: 18/463,920

(22) Filed: Sep. 8, 2023

(51) Int. Cl. H04W 52/02

(52) U.S. Cl. CPC H04W 52/0235

(57) ABSTRACT

Certain aspects of the present disclosure provide techniques for using downlink control information (DCI) to trigger low power (LP) wake-up signal (WUS) monitoring. A method includes receiving, via a first receiver (e.g., a main receiver) of a user equipment (UE) while in an active mode, DCI that triggers monitoring for a WUS by a second receiver (e.g., a LP wake-up receiver (LP-WUR)) of the UE, wherein the WUS is associated with a first discontinuous reception (DRX) ON duration configured for the first receiver; in response to receiving the first DCI: transitioning, by the first receiver, from the active mode to an inactive mode; transitioning, by the second receiver, from the inactive mode to the active mode; and monitoring, by the second receiver while in the active mode, for the WUS during a WUS monitoring duration

### INTRODUCTION

### Field of the Disclosure

Aspects of the present disclosure relate to wireless communications, and more particularly, to techniques for using downlink control information (DCI) to trigger low-power (LP) wake-up signal (WUS) monitoring.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving, via a first receiver of the apparatus while in an active mode, first downlink control information (DCI) that triggers monitoring for a wake-up signal (WUS) by a second receiver of the apparatus, wherein the WUS is associated with a first discontinuous reception (DRX) ON duration configured for the first receiver; transitioning, by the first receiver, from the active mode to an inactive mode, in response to receiving the first DCI; transitioning, by the second receiver, from the inactive mode to the active mode, in response to receiving the first DCI; and monitoring, by the second receiver while in the active mode, for the WUS during a WUS monitoring duration, in response to receiving the first DCI.

Another aspect provides a method for wireless communications by an apparatus. The method includes determining to transmit data during a first DRX ON duration configured for a first receiver of a user equipment (UE); and transmitting a first DCI triggering monitoring for a WUS by a second receiver of the UE, wherein the WUS is associated with the first DRX ON duration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example user equipment configured with a low power wake-up receiver and a main receiver.

FIG. 6 depicts an example procedure using a wake-up signal mechanism.

FIG. 7A depicts a process flow for communicating data between a network entity and a user equipment, while operating the user equipment in a power-efficient manner.

FIG. 7B depicts example associations between physical downlink control channel (PDCCH) monitoring occasions and various wake-up signal monitoring configurations.

FIG. 8 depicts a process flow for communicating data between a network entity and a user equipment where a low power wake-up signal is not detected by the user equipment.

FIG. 9 depicts an example scenario where a user equipment monitors for a low power wake up signal in multiple wake up signal monitoring intervals.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure relate to techniques for using downlink control information (DCI) to trigger low-power (LP) wake-up signal (WUS) (LP-WUS) monitoring by a low-power wake-up receiver (LP-WUR). An LP-WUS may have a simpler waveform (e.g., on-off keying (OOK), which is a simple form of amplitude-shift keying (ASK) modulation, or frequency-shift keying (FSK)) than a WUS transmitted via a DCI, for example. Further, an LP-WUS may require a simpler receive function than a WUS (e.g., may require a more complex receive function).

LP-WURs are a power saving mechanism used in wireless communication systems to help save power at a user equipment (UE) by enabling a main receiver of the UE to remain in a low power, sleep state (also referred to herein as an “inactive mode”) until data intended for the UE is to be transmitted. Specifically, a UE may be configured with a main receiver and an LP-WUR. The main receiver may be configured to receive downlink data from a network entity, while the LP-WUR may be configured to receive LP-WUSs from the network entity. The LP-WUR may remain awake at frequent intervals to monitor for a LP-WUS. A LP-WUS may be transmitted to the UE, by a network entity, when the network entity determines that there is data to send to the UE. When a LP-WUS is detected by the LP-WUR, the LP-WUR may trigger the main receiver to transition from an inactive mode to an active mode and begin monitoring for the downlink data. Monitoring for LP-WUSs with the LP-WUR may beneficially consume significantly less power compared to monitoring for downlink data with the main receiver, thereby significantly reducing power consumption at the UE.

However, requiring a UE to monitor (e.g., periodically, and in some cases, periodically with very short periodicity such that the monitoring appears almost continuous) for LP-WUSs for an extended period of time presents a technical problem. Specifically, prolonged periods of LP-WUS monitoring by an LP-WUR may negatively impact the performance of the LP-WUR, given long and frequent monitoring periods contribute to the probability of LP-WUS false alarm(s) (e.g., false detection of LP-WUS) by the LP-WUR False detection of low power signaling may increase as the time the LP-WUR remains active increases. In particular, if a UE performs detection for an extended period of time, there may be a higher chance of false detection due to the increased period of detection and/or noise. For example, random noise may be seen as an LP-WUS when detections are performed often. Further, longer periods of LP-WUR activation may not always be necessary and thus leaves room for additional power efficiency gains at the UE.

Accordingly, certain aspects described herein provide a technical solution to the aforementioned technical problems by enabling the use of LP-WUS signaling in combination with DCI-based WUS monitoring triggers. In particular, an LP-WUR of a UE may be powered down (e.g., in an inactive mode) until a DCI is received by a main receiver of the UE, where the DCI triggers monitoring for an LP-WUS by the LP-WUR. The DCI may be received by the main receiver during a discontinuous reception (DRX) ON duration where the main receiver is actively monitoring for downlink data (e.g., at other times, during DRX OFF durations, the main receiver may be in an inactive mode for power saving). In response to receiving the DCI, the main receiver may enter into an inactive mode and the LP-WUR may wake up to begin monitoring for an LP-WUS. When an LP-WUS is detected by the LP-WUR, the main receiver may be triggered to wake up (e.g., transition from an inactive mode to an active mode) and begin monitoring for downlink data, while the LP-WUR returns to an inactive mode. As such, downlink monitoring (e.g., physical downlink control channel (PDCCH) monitoring) by the main receiver and LP-WUS monitoring by the LP-WUR may be balanced to achieve minimal power consumption at the UE while maximizing responsiveness to wake up signals.

Further, certain aspects provide mechanisms for indicating when a UE is to begin monitoring for a LP-WUS and a maximum time for monitoring for the LP-WUS (e.g., a WUS monitoring duration). Regardless of whether or not a LP-WUS is detected by the LP-WUR during the WUS monitoring duration, the LP-WUR may transition back to an inactive mode after the WUS monitoring duration is completes. Operating the LP-WUR in this discontinuous fashion may beneficially reduce the likelihood of LP-WUS misdetection by the LP-WUR and further reduces power consumption at the UE.

By dynamically controlling LP-WUS monitoring by the LP-WUR of the UE and PDCCH monitoring by the main receiver of the UE in a discontinuous fashion with triggering, monitoring time may be configured and limited to periods when a network entity determines to transmit data to the UE, thereby improving power savings at the UE. This technical effect may be particularly beneficial in extended reality (XR), ultra-reliable low latency communications (URLLC), and/or enhanced mobile broadband (eMBB) use cases where data transmissions to the UE are aperiodic. In such cases, DCI triggering allows the LP-WUR to remain in an inactive mode and save power resources at the UE when no data is scheduled for the UE.

### Introduction to Wireless Communications Networks

The techniques and methods described herein may be used for various wireless communications networks. While aspects may be described herein using terminology commonly associated with 3G, 4G, 5G, 6G, and other generations of wireless technologies, aspects of the present disclosure may likewise be applicable to other communications systems and standards not explicitly mentioned herein.

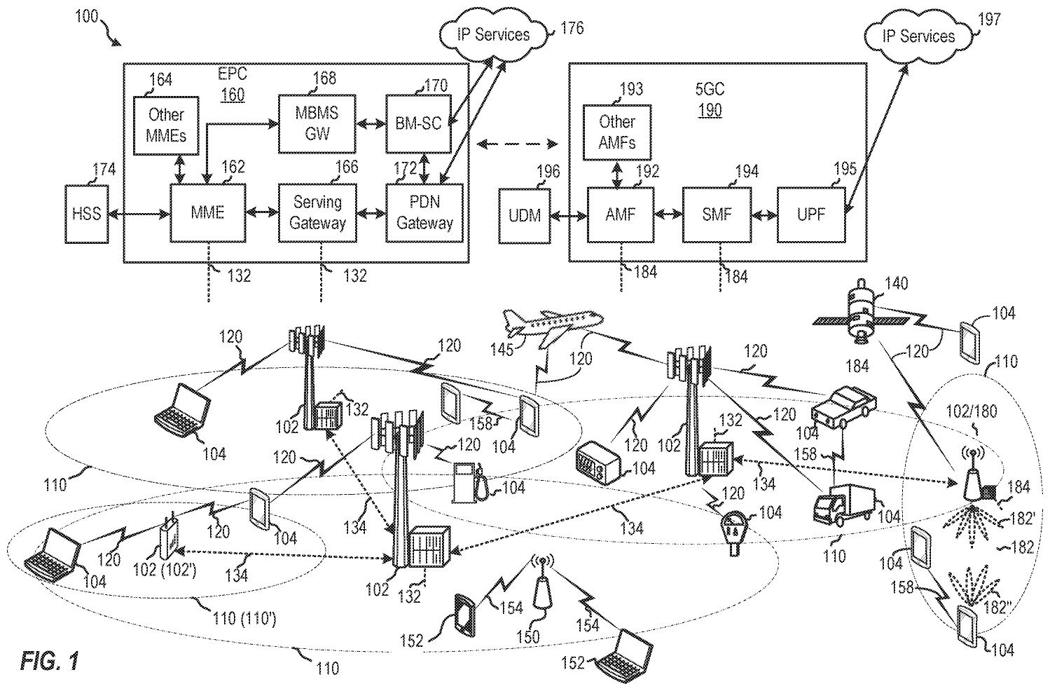

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell.

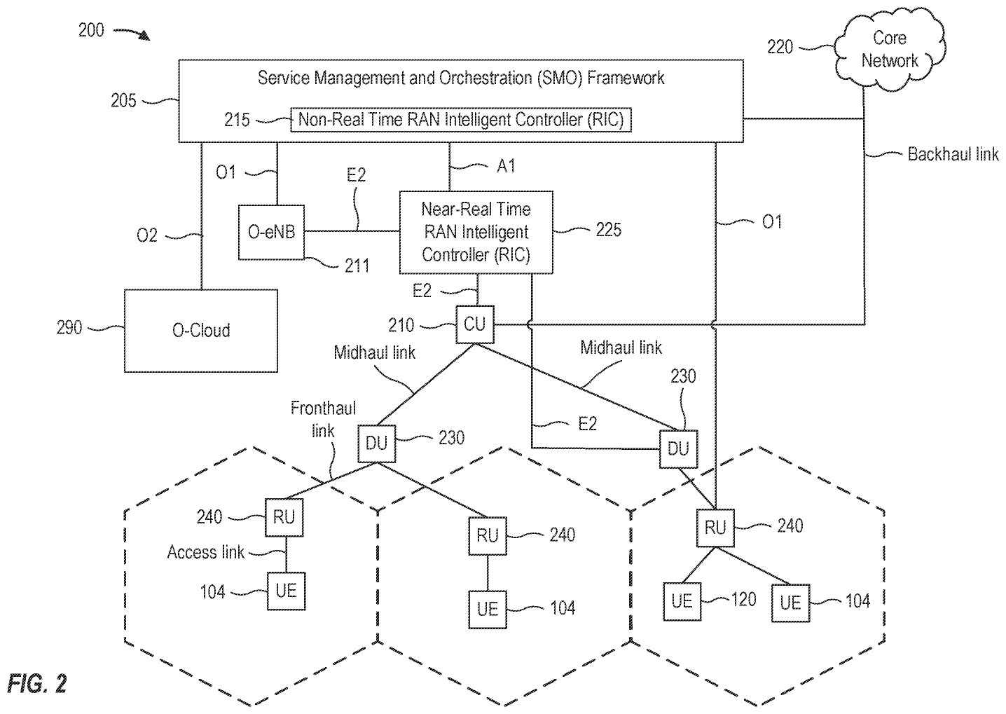

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

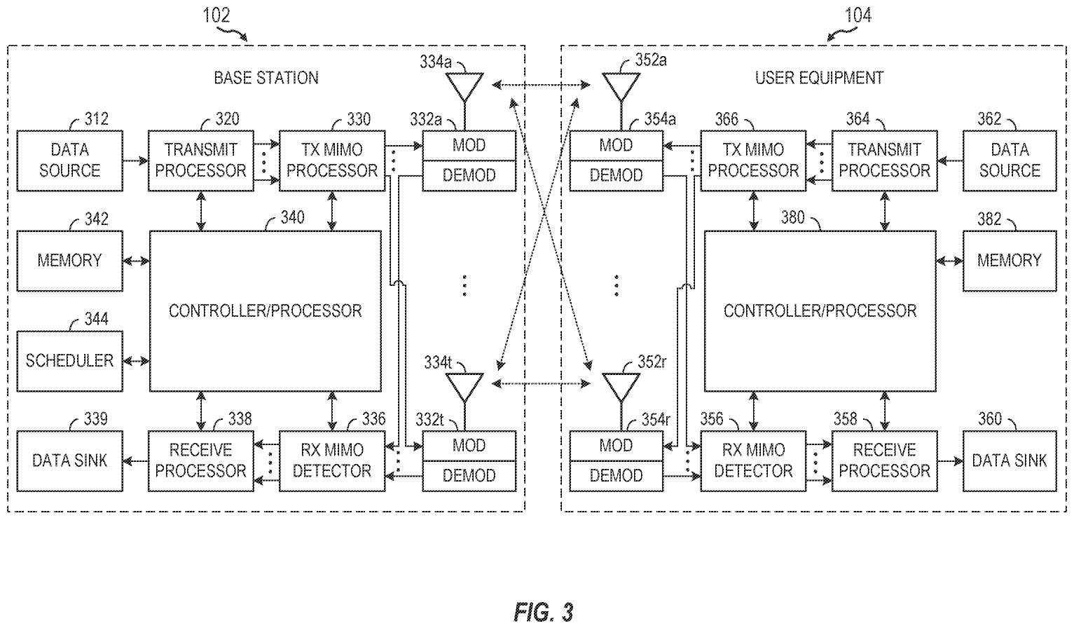

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

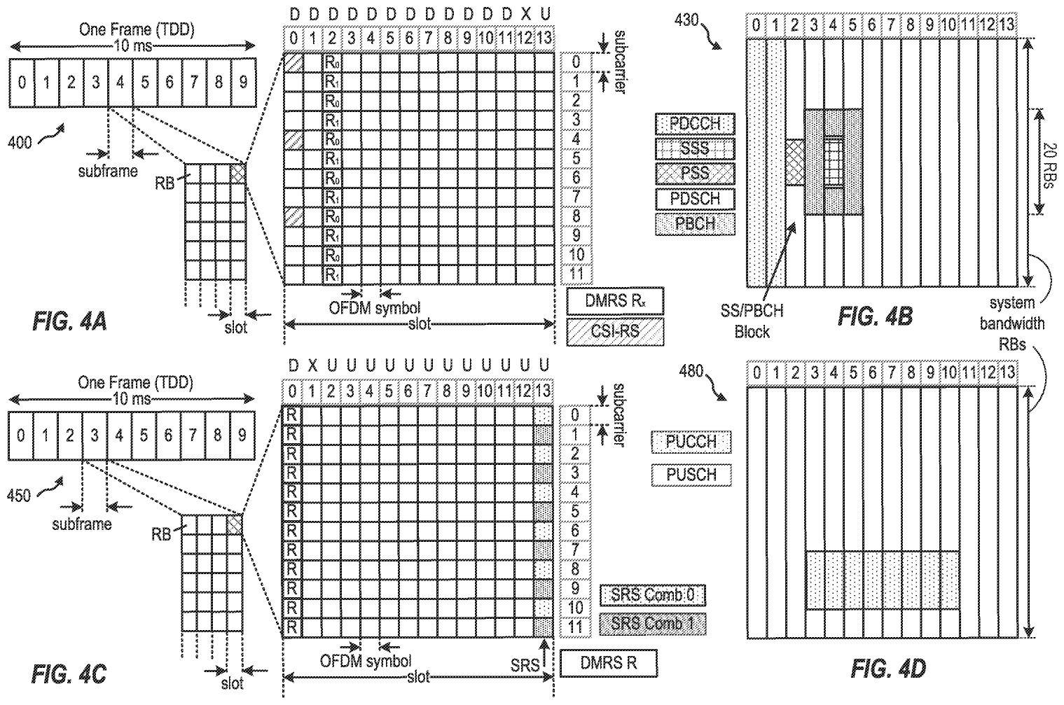

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Low-Power Wake-Up Receiver Systems

Energy efficiency is a key consideration for communication systems to achieve sustainability and scalability of such systems. One energy-saving approach for wireless communications includes the use of a low-power wake-up receiver (LP-WUR) (also referred to as a “low-power wake-up radio”) to monitor for certain signals (e.g., low-power wake-up signals (LP-WUSs), also simply referred to as “WUSs”) in lieu of a higher power main receiver. The LP-WUR beneficially allows a communication device (e.g., a UE) to remain in a very low-power (or no-power) state until a period of time in which a communication intended for the device is transmitted to the device.

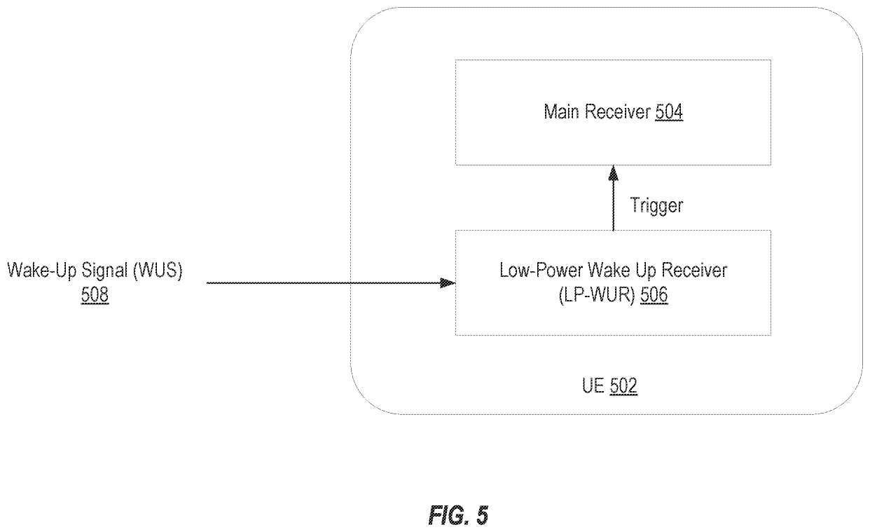

FIG. 5 depicts an example UE 502 (e.g., such as UE 104 described above with respect to FIGS. 1 and 3) configured with an LP-WUR 506 and a main receiver 504 (also referred to as a “main radio”). Main receiver 504 is a receiver of UE 502 configured to receive downlink data from a network entity (e.g., such as such as BS 102 of FIGS. 1 and 3, or a disaggregated base station as discussed with respect to FIG. 2) when main receiver 504 is powered on. However, main receiver 504 generally remains powered down in the absence of scheduled downlink data to help conserve power at UE 502.

LP-WUR 506 enables main receiver 504 to remain in a powered down state, and thus conserve energy. In particular, LP-WUR 506 is a relatively simpler receiver (e.g., does not include a transmitter) that remains awake continuously (or at high-frequency intervals) to monitor for an LP-WUS 508. LP-WUS 508 is used to trigger LP-WUR 506 to wake up main receiver 504 of UE 502 to receive downlink data. LP-WUS 508 may be transmitted to UE 502, by a network entity, when the network entity determines that there is data to send to UE 502, which is received by main receiver 504.

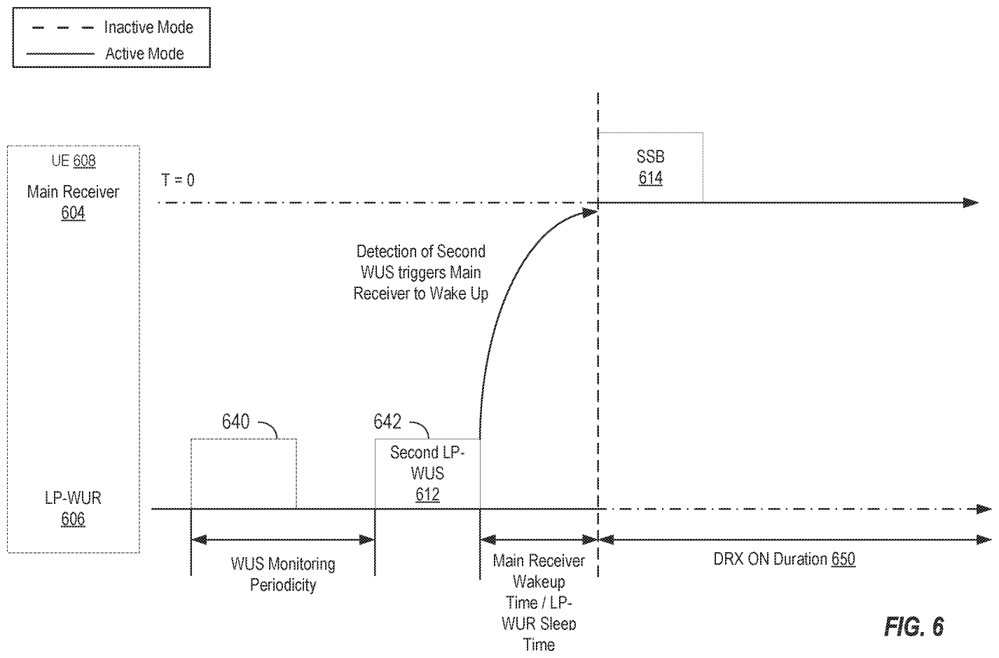

FIG. 6 depicts an example procedure 600 using an LP-WUS mechanism to wake-up a main receiver for receiving downlink data.

As depicted, a UE 608 is configured with a main receiver 604 and an LP-WUR 606 (e.g., similar to UE 502 with main receiver 504 and LP-WUR 506 in FIG. 5). At time T=0, UE 608 is in a radio resource control (RRC) connected state, meaning that UE 608 is powered on, is connected to a network, and radio resources are allocated to UE 608 for communication. However, at time T=0, only LP-WUR 606 of UE 608 is in an active mode (also referred to as an “powered on state” or “awake state”), while main receiver 604 of UE 608 is in an inactive mode (also referred to as a “powered off state” or “sleep state”) and unable to receive downlink data from the network, such as downlink control information (DCI) via a physical downlink control channel (PDCCH).

LP-WUR 606 is configured to actively monitor for LP-WUSs from the network while main receiver 604 is in the powered off state. In this example, LP-WUR 606 is configured to monitor for an LP-WUS according to a WUS monitoring periodicity. For example, the WUS monitoring periodicity may be defined as a plurality of symbols, a plurality of slots, a fixed time duration, etc. LP-WUR 606 may be configured to monitor for an LP-WUS in periodic LP-WUS monitoring occasions (e.g., such as LP-WUS monitoring occasion 640 and LP-WUS monitoring occasion 642), where LP-WUS may be sent by a network entity. The WUS monitoring periodicity may define the separation in time between start times of different WUS monitoring occasions 640, 642.

In this example, an LP-WUS 612 is transmitted to UE 608 in LP-WUS monitoring occasion 642; thus, LP-WUR 606 receives LP-WUS 612 in LP-WUS monitoring occasion 642 when monitoring for LP-WUS 612.

LP-WUS 612 may be transmitted by a network entity to UE 608 and received by LP-WUR 606, when downlink data is intended to be sent by the network entity to UE 608 in an upcoming discontinuous reception (DRX) ON duration 650. In particular, DRX is another power-saving mechanism used to limit when UE 608, and more specifically, main receiver 604, monitors the PDCCH. UE 608 may be configured with durations of (1) DRX ON where main receiver 604 is actively monitoring for downlink data and (2) DRX OFF where main receiver 604 is in a power saving mode.

LP-WUS 612 received by LP-WUR 606 triggers UE 608 to wake up main receiver 604 to receive data in an upcoming DRX ON duration 650 (e.g., given downlink data is expected to be transmitted and received by main receiver 604 during this duration). After detecting LP-WUS 612, LP-WUR 606 transitions from the active mode to an inactive mode because when the main receiver 604 is on, LP-WUR 606 need not be monitoring for any LP-WUSs. Further, in response to the trigger from LP-WUR 606, main receiver 604 transitions from the inactive mode to an active mode to monitor for downlink data during the upcoming DRX ON duration 650.

During the DRX ON duration 650, main receiver 604 receives one or more reference signals (RSs), such as synchronization signal block (SSB) 614. For example, main receiver 604 measures the one or more RSs to synchronize with a network entity intended to send downlink data to main receiver 604, as well as perform beam management for communication with the network entity.

Further during the DRX ON duration, main receiver 604 monitors for downlink data from a network entity.

As shown in FIG. 6, power saving is achieved by keeping main receiver 604 in an inactive mode (e.g., micro-sleep) until a WUS is detected by LP-WUR 606. Instead of main receiver 604 continuously monitoring the PDCCH for downlink data, main receiver 604 may remain inactive until data is determined to be sent to main receiver 604 as indicated by reception of the WUS by LP-WUR 606. By not continuously monitoring the PDCCH, UE 608 may save significant power (e.g., 50-60% compared to implementations without LP-WUR 606 in some implementations).

While the LP-WUR 606 does beneficially save power in UE 608, having the LP-WUR 606 continuously monitor for low power signals still leaves room for power efficiency gains, and therefore presents a technical problem. Further, actively monitoring by LP-WUR 606 for LP-WUS for extended periods of time may increase the incidence of false alarms by the UE indicating the detection of low power signals.

Accordingly, technical problems exist in regard to how to configure the LP-WUR for discontinuous monitoring to further improve power efficiency and reduce the incidence of misdetection. Aspects described below provide technical solutions to these issues.

### Aspects Related to Downlink Control Information-Based Low-Power Wake-Up Signal Monitoring

In order to overcome technical problems associated with conventional LP-WUR systems, such as the example described above with respect to FIG. 5, aspects described herein utilize DCI-based WUS monitoring triggers to cause a LP-WUR to become active and monitor for an LP-WUS in a discontinuous fashion, thereby achieving increased power savings for both a main receiver and the LP-WUR of a UE. For example, instead of operating in an active mode for an extended period of time, the LP-WUR of the UE may be placed in a low-power state (e.g., in an inactive mode) until a DCI is received by the main receiver of the UE, the DCI being configured to trigger monitoring for an LP-WUS by the LP-WUR. In response to receiving the DCI, the main receiver may transition into an inactive mode, and the LP-WUR may transition into an active mode (e.g., wake up) for monitoring for the LP-WUS. As such, aspects described herein may utilize first signaling for transitioning the LP-WUR (e.g., a DCI detected by the main receiver) from an inactive mode to an active mode and second signaling for transitioning the main receiver (e.g., an LP-WUS detected by the LP-WUR) from an inactive mode to an active mode.

Additionally, aspects described herein may beneficially limit the amount of time the LP-WUR is expected to monitor for an LP-WUS. For example, in some aspects, the LP-WUR may not be triggered to wake up and monitor for the LP-WUS until a period of time after the DCI is detected by the main receiver. Further, in some aspects, the LP-WUR may be configured to monitor for an LP-WUS for a limited amount of time (e.g., a limited monitoring duration). The offset and/or the monitoring duration may be based on an amount of jitter present between the UE and a network entity in communication with the UE. Specifically, jitter is a variance in latency, which is the time delay between when a signal is transmitted and when it is received. Jitter between the UE and the network entity may cause an LP-WUS and/or downlink data intended for the UE to be delayed at arrival (e.g., arrive later in time than expected). This additional amount of time caused by jitter in the communication path may be used to determine an offset and/or the WUS monitoring duration for the LP-WUR to optimize the amount of time the LP-WUR is monitoring for the WUS and, in some cases, the amount of time the main receiver is monitoring for downlink data after being woken up by the LP-WUR.

Further, in some aspects described herein, a main receiver of a UE may transition from an inactive state to an active state even in the absence of LP-WUS detection by an LP-WUR of the UE. In particular, in cases where a UE receives DCI triggering an LP-WUR to begin monitoring for an LP-WUS (because data is to be transmitted to the UE in a next DRX ON duration), and the LP-WUR is unable to receive an LP-WUS within a configured or indicated WUS monitoring duration, the main receiver may begin monitoring for downlink data. Enabling the main receiver to begin monitoring for downlink data in cases where an LP-WUS is not received by the LP-WUR enables UE to still receive the downlink data intended for the UE. As such, the inability of LP-WUR to receive the LP-WUS may not affect the ability of the UE to receive data in a next DRX ON duration where data is expected to be sent to the UE. This may help to improve overall communication between the network entity and the UE, while also avoiding using additional resources for re-transmission of such data in a subsequent DRX ON duration.

Such monitoring may begin after a period of time it takes for the main receiver to turn on after the WUS monitoring duration is complete. Thus, in cases where the offset and/or WUS monitoring duration are based on an amount of jitter in a communication path between the UE and the network entity (e.g., thereby causing the monitoring duration to be delayed in time), the main receiver may begin monitoring for the downlink data later in time. Accordingly, power may be conserved at the UE due to the fact that the main receiver is not monitoring for the downlink data during a time when the downlink data is not expected (e.g., due to jitter in the channel). Instead, the UE may delay the beginning of monitoring for the downlink data closer to the actual arrival time of the data (e.g., based on jitter).

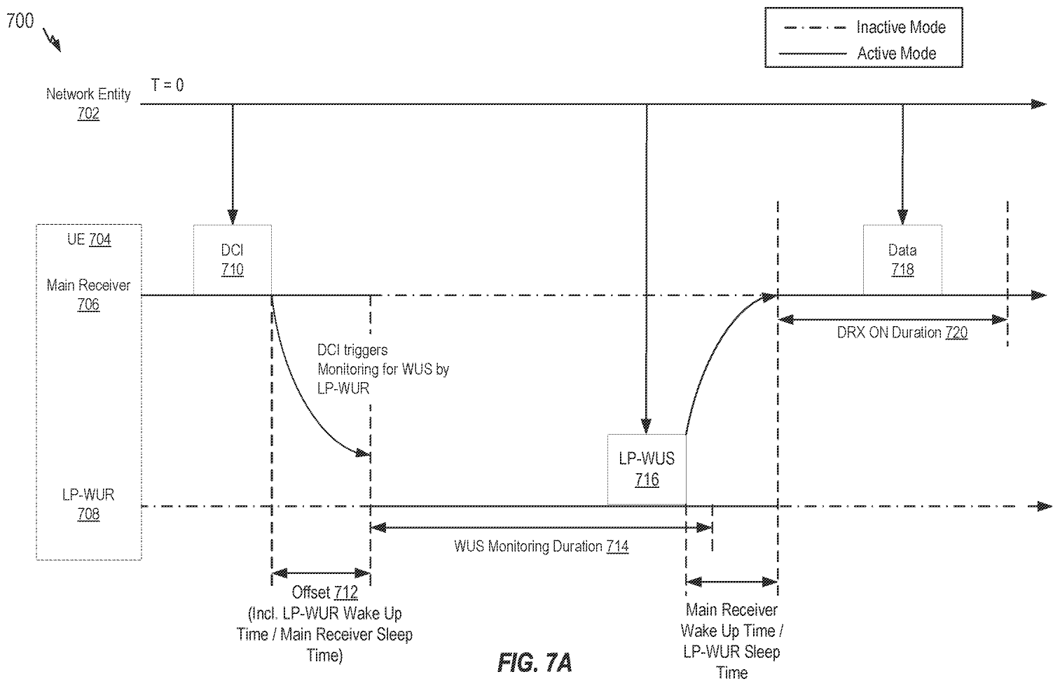

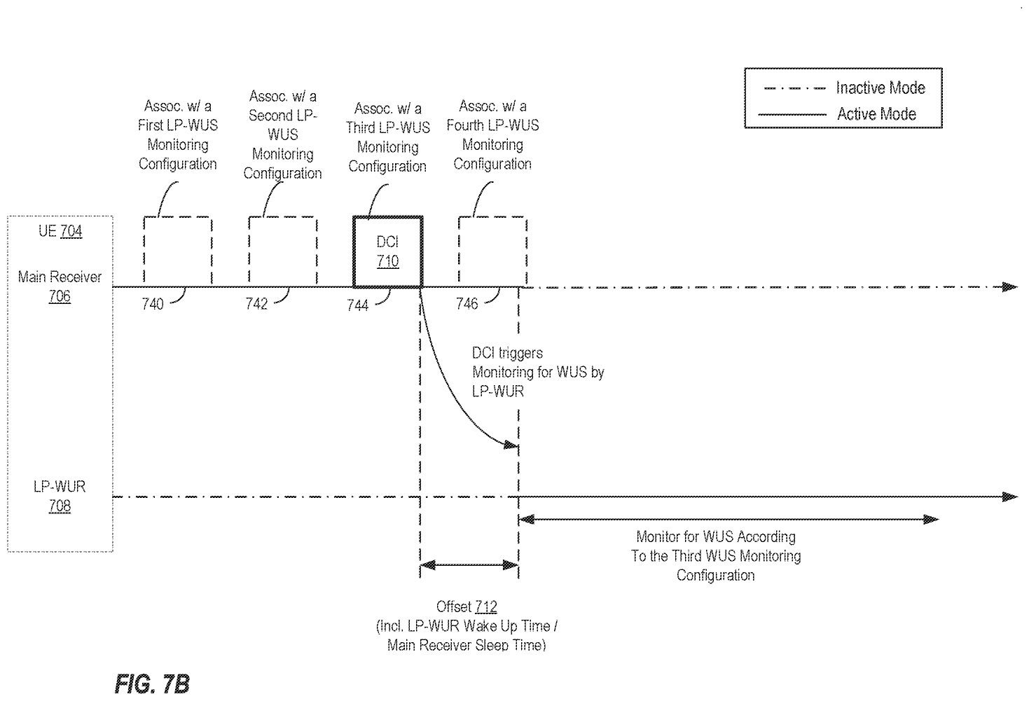

FIG. 7A depicts a process flow 700 for communications in a network between a network entity 702 and a UE 704, and more specifically between network entity 702, a main receiver 706 of UE 704, and an LP-WUR 708 of UE 704. In some aspects, network entity 702 is an example of the BS 102 depicted and described with respect to FIG. 1 and 3 or a disaggregated base station depicted and described with respect to FIG. 2. Similarly, the UE 704 is an example of UE 104 depicted and described with respect to FIGS. 1 and 3. However, in other aspects, UE 104 may be another type of wireless communications device and BS 102 may be another type of network entity or network node, such as those described herein.

Process flow 700 may be used to communicate data between network entity 702 and UE 704, while operating UE 704 in a power-efficient manner. Specifically, DCI-based signaling and LP-WUS signaling may be used to allow both main receiver 706 and LP-WUR 708 to remain in an inactive mode until downlink data is determined to be transmitted to UE 704 and received by main receiver 706.

For example, as shown in FIG. 7A, at time T=0, LP-WUR 708 of UE 704 is in an inactive mode, while main receiver 706 of UE 704 is in active mode. Accordingly, main receiver 706 is powered on and able to monitor for downlink signals from network entity 702. During the monitoring, main receiver 706 receives DCI 710 from network entity 702. In some aspects, DCI 710 is a DCI 2_6 format. In some aspects, DCI 710 is used to provide DCI group common signaling. This type of DCI is designed to address a group of UEs, including UE 704, and can accommodate payloads for each UE within the group. The payload belonging to a UE 704 has a specific position within DCI 710 such that UE 704 is able to extract its own information while ignoring the information intended for other UE(s).

Network entity 702 may transmit DCI 710 to UE 704 after determining that downlink data is ready to be transmitted to UE 704 in a next (e.g., upcoming) DRX ON duration configured for UE 704. In response to DCI 710, main receiver 706 transitions from the active state to an inactive state (e.g., a sleep state) and LP-WUR 708 transitions from an inactive state to an active state (e.g., wakes up). The transition to the active state by LP-WUR 708 allows LP-WUR 708 to begin monitoring for an LP-WUS from network entity 702. As described above, the LP-WUS may be sent later to trigger waking up main receiver 706 to receive the downlink data from network entity 702.

In some aspects, a WUS monitoring duration 714 in which LP-WUR 708 begins monitoring for an LP-WUS begins after a time offset 712 measured from a last symbol of the received DCI 710. Alternatively, in some other aspects, LP-WUR 708 begins monitoring for an LP-WUS after a time offset 712 from a predefined slot or microslot boundary (such as the end of a slot). As another alternative, in some aspects, LP-WUR 709 begins monitoring for an LP-WUS after a time offset 712 measured from another reference point in time. In any case, an indication of the offset (e.g., the offset time period) may be transmitted to UE 704 via L1, L2, or L3 signaling, such as RRC signaling, medium access control control element (MAC-CE) signaling, or in DCI signaling. In some aspects, the indication of the offset may be included in DCI 710 received by main receiver 706. In particular, additional bits may be added to DCI 710 to indicate offset 712.

As indicated above, LP-WUR 708 monitors for an LP-WUS (e.g., from network entity 702) during WUS monitoring duration 714. In some aspects, LP-WUR 708 receives an indication of the WUS monitoring duration 714 from network entity 702. In some aspects, network entity 702 may determine a value for WUS monitoring duration 714 based on a measurement or estimate of jitter in a communication channel between network entity 702 and UE 704. In some aspects, network entity 702 may estimate the jitter based on statistics of jitter for the communication channel. WUS monitoring durations (such as 714) may be the same or different as indicated by different DCIs (e.g., 710) received at UE 704.

In some aspects, LP-WUR 708 determines an LP-WUS monitoring configuration for monitoring for an LP-WUS based on a PDCCH monitoring occasion where DCI 710 was received by main receiver 706. In particular, there may exist associations between PDCCH monitoring occasions (e.g., for monitoring for DCI 710) and various WUS monitoring configurations.

FIG. 7B depicts example associations between PDCCH monitoring occasions and various LP-WUS monitoring configurations. As shown, main receiver 706 may be configured to monitor four PDCCH monitoring occasions 740-746 for DCI. PDCCH monitoring occasion 740 may be associated with a first LP-WUS monitoring configuration. PDCCH monitoring occasion 742 may be associated with a second LP-WUS monitoring configuration. PDCCH monitoring occasion 744 may be associated with a third LP-WUS monitoring occasion. Lastly, PDCCH monitoring occasion 746 may be associated with a fourth LP-WUS monitoring configuration. For example, first, second, third, and fourth LP-WUS monitoring occasions may each define a start time that LP-WUR 708 is to begin monitoring for an LP-WUS (e.g., a WUS monitoring duration start time), the amount of time for the WUS monitoring duration, and/or an interval between WUS monitoring occasions for monitoring for an LP-WUS during the WUS monitoring duration.

In the example in FIG. 7B, based on monitoring for DCI in in PDCCH monitoring occasions 740-746, main receiver 706 may detect DCI 710 in PDCCH monitoring occasion 744. Because PDCCH monitoring occasion 744 is associated with at third LP-WUS monitoring configuration, LP-WUR 708 may monitor for an LP-WUS according to the third LP-WUS monitoring configuration (e.g., begin monitoring at a time defined in the third LP-WUS monitoring configuration, monitor for an LP-WUS monitoring duration indicated in the third LP-WUS monitoring configuration, etc.).

Returning to FIG. 7A, in some cases, LP-WUR 708 detects an LP-WUS 716 (e.g., transmitted to UE 704) during the WUS monitoring duration and in response triggers LP-WUR 708 to wake up main receiver 706 to receive data in an upcoming or current DRX ON duration (e.g., given downlink data is expected to be transmitted to main receiver 706 during this duration). After detecting LP-WUS 716, LP-WUR 708 transitions from the active mode to an inactive mode. Further, in response to the trigger from LP-WUR 708, main receiver 706 transitions from the inactive mode to an active mode to monitor for one or more transmissions during DRX ON duration 720. Based on the monitoring, main receiver 706 detects downlink data 718 (e.g., transmitted from network entity 702).

In some aspects, there exists associations between PDCCH monitoring occasions (e.g., for monitoring for DCI 710) and search space set groups that are to be monitored by main receiver 706 after being woken up by LP-WUR 708. For example, a first PDCCH monitoring occasion may be associated with a first search space set group, a second PDCCH monitoring occasion may be associated with a second search space set group, a third PDCCH monitoring occasion may be associated with a third search space set group, etc. Thus, if the DCI is detected in the first PDCCH monitoring occasion, then when main receiver 706 is woken up at a later point in time to monitor for one or more transmissions, main receiver 706 monitors for the transmission(s) in the first search space set group (e.g., associated with the first PDCCH monitoring occasion) during the DRX ON duration.

Alternatively, in some aspects, one or more bits included in LP-WUS 716 indicate the search space set group to be monitored by main receiver 706 after main receiver 706 transitions to an active mode to begin monitoring for one or more downlink transmissions. For example, LP-WUS 716 may include additional bits (e.g., at least one of the total bits of LP-WUS 716) indicating a search space set group to be monitored by main receiver 706 during the upcoming or current DRX ON duration.

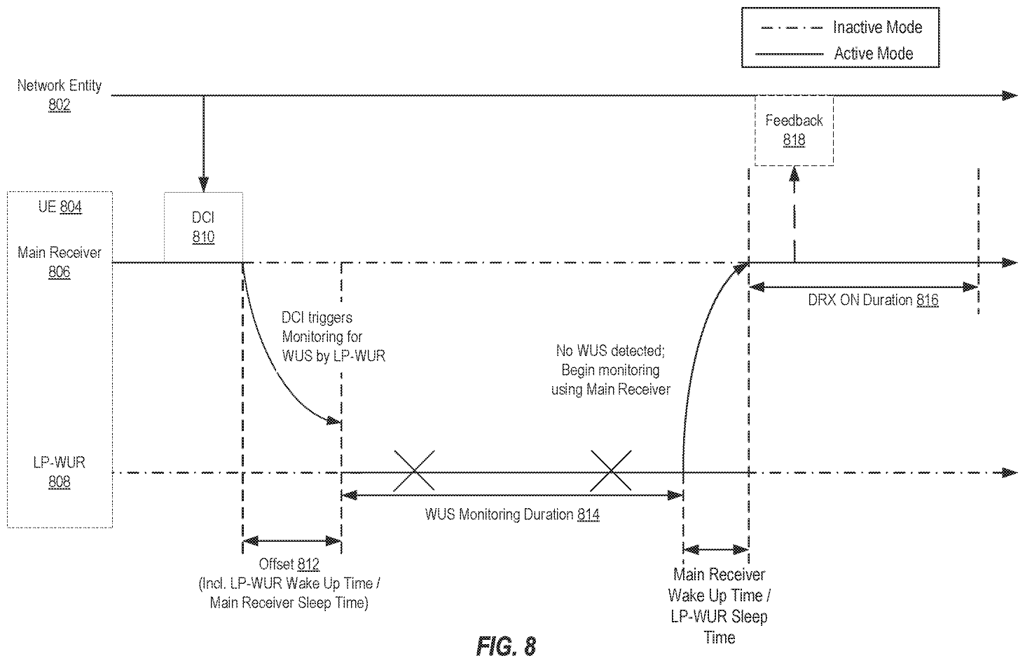

In some aspects, a LP-WUR of a UE may not detect an LP-WUS during a WUS monitoring duration configured for the LP-WUR. In such cases, the UE may take one or more actions. Example action(s) that may be taken by UE are described below in FIG. 8.

FIG. 8 depicts a process flow 800 for communicating data between a network entity 802 and a UE 804, and more specifically, main receiver 806 and LP-WUR 808 of UE 804, where a LP-WUS is not detected by LP-WUR 808. In some aspects, network entity 802 is an example of the BS 102 depicted and described with respect to FIGS. 1 and 3 or a disaggregated base station depicted and described with respect to FIG. 2. Similarly, the UE 804 is an example of UE 104 depicted and described with respect to FIGS. 1 and 3. However, in other aspects, UE 104 may be another type of wireless communications device and BS 102 may be another type of network entity or network node, such as those described herein.

Similar to process flow 700, process flow 800 in FIG. 8 begins by main receiver 806 of UE 804 receiving a DCI 810 transmitted from network entity 802. Network entity 802 may transmit DCI 810 to UE 804 after determining that downlink data is to be transmitted to UE 804 in a next (e.g., upcoming) DRX ON duration configured for UE 804. Thus, DCI 810, when received by main receiver 806, triggers main receiver 806 to transition from an active state to an inactive state and LP-WUR 808 of UE 804 to transition from an inactive state to an active state. The transition to the active state by LP-WUR 808 enables LP-WUR 808 to begin monitoring for an LP-WUS from network entity 802.

LP-WUR 808 may begin monitoring for an LP-WUS at a time based on an offset 812 from a last symbol where DCI 810 was received, a predefined slot, or another reference point in time (e.g., an absolute time). LP-WUR 808 may monitor for the LP-WUS for a WUS monitoring duration 814.

Unlike process flow 700 described with respect to FIG. 7, however, in process flow 800, LP-WUR 808 may not detect an LP-WUS during WUS monitoring duration 814. In some aspects, when an LP-WUS is not detected during WUS monitoring duration 814, LP-WUR 808 may determine that a misdetection error (e.g., LP-WUR 808 failed to successfully detect and receive an LP-WUS intended for UE 804) has occurred and accordingly begin using main receiver 806 to monitor for downlink data even though the WUS was not received. More specifically, after WUS monitoring duration 814, LP-WUR 808 transitions from an active mode to an inactive mode, while main receiver 806 transitions from an inactive mode to an active mode. While in the active mode, main receiver 806 monitors for one or more downlink transmissions from network entity 802 during a DRX ON duration 816 (e.g., an upcoming or current DRX ON duration 816).

In some aspects, main receiver 806 is configured to monitor for the one or more transmissions in a default search space set group configured for UE 804. In some other aspects, an indication of a search space set group to monitor is included in DCI 810, and main receiver 806 monitors for the one or more transmissions in the search space set group indicated via DCI 810. In some other aspects, an indication of a search space set group to monitor is included in a second DCI (not DCI 810). The second DCI may be a non-scheduling DCI used to configure one or more parameters for LP-WUR 808. Accordingly, main receiver 806 monitors for the one or more transmissions in the search space set group indicated via the second DCI.

In some aspects, prior to WUS monitoring duration 814 ending, LP-WUR 808 determines that LP-WUR 808 will be unable to detect an LP-WUS during the WUS monitoring duration 814 (for example, due to poor channel conditions and/or strong interference degrading signal-to-noise ratio (SNR)). Accordingly, based on this determination, LP-WUR 808 may determine to stop monitoring for an LP-WUS prior to the end of WUS monitoring duration 814 and trigger monitoring for downlink data by main receiver 806. As such, WUS monitoring by LP-WUR 808 may be terminated early, and LP-WUR 808 may transition from an active mode to an inactive mode, while main receiver 806 transitions from an inactive mode to an active mode.

In some aspects, after not receiving an LP-WUS during WUS monitoring duration 814 and switching to monitoring for downlink data by main receiver 806, main receiver 806 may transmit feedback 818 to network entity 802 indicating that LP-WUR 808 was unable to successfully receive an LP-WUS during WUS monitoring duration 814. In response to receiving feedback 818, network entity 802 may perform one or more rectifying actions. In some aspects, the one or more actions include asking UE 804 to stop monitoring for LP-WUS. In some aspects, the one or more actions include performing beam management with UE 804 to determine a beam pair capable of providing sufficient throughput performance for transmission of future LP-WUSs to UE 804. In some cases, performing beam management involves simply switching receive beams of LP-WUR. In some cases, main receiver 806 aids LP-WUR 808 in performing the beam management with UE 804. For downlink communications, a beam pair may include a UE 804 receive beam and a network entity 802 transmit beam. In some aspects, the one or more actions include transmitting LP-WUSs with repetition to increase the likelihood of UE 804 receiving the LP-WUSs. In some aspects, the one or more actions include assigning additional resources for transmitting LP-WUSs. In some aspects, the one or more actions include changing a waveform, a modulation, and/or a coding rate of LP-WUSs. For example, if network entity 802 and UE 804 support more than one type and/or format of low power signals, then network entity 802 may use sequence-based OFDM instead of on-off keying (OOK) (e.g., a simple form of amplitude-shift keying (ASK) modulation).

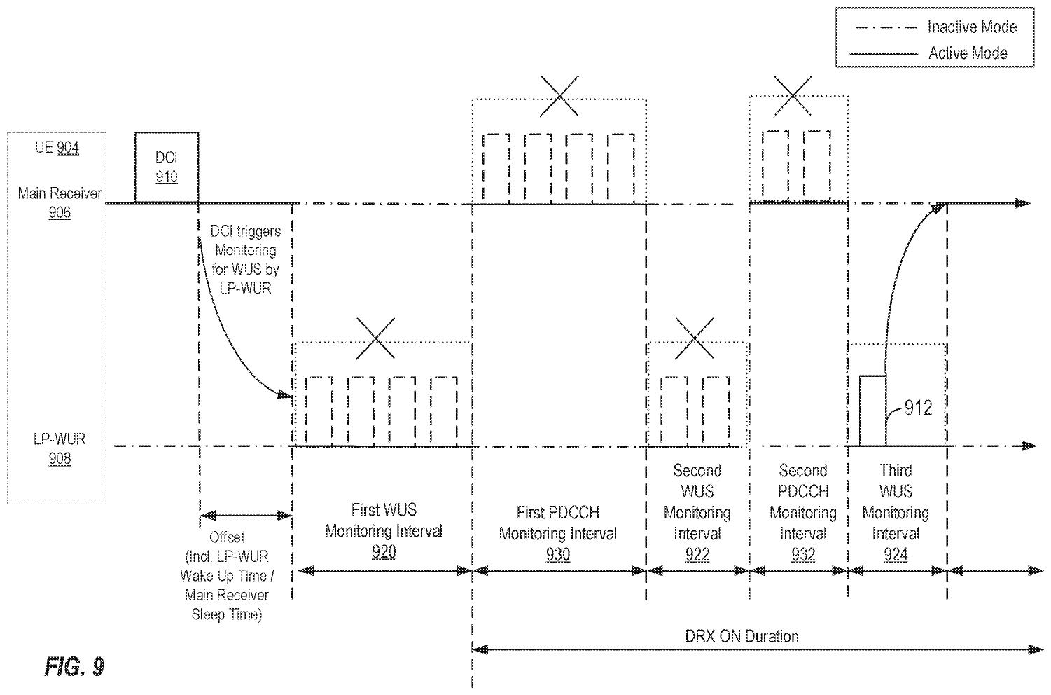

In some aspects, an LP-WUS monitoring duration for monitoring for LP-WUS is broken into multiple first intervals, and a DRX ON duration for monitoring for downlink data from a network entity is broken into multiple second intervals. This is depicted in FIG. 9.

For example, as shown in FIG. 9, a WUS monitoring duration may be separated into three non-contiguous first intervals: a first WUS monitoring interval 920, a second WUS monitoring interval 922, and a third WUS monitoring interval 924. The second WUS monitoring interval 922 and the third WUS monitoring interval 924 may occur during at least a portion of the DRX ON duration 940 configured for main receiver 906 of UE 904. Further, the DRX ON duration 940 may also be separated into at least two noncontiguous intervals: a first PDCCH monitoring interval 930 and a second PDCCH monitoring interval 9 932. Each WUS monitoring interval 920, 922, 924 may include a respective set (e.g., where a set includes one or more) of LP-WUS monitoring occasions that LP-WUR 708 may monitor for an LP-WUS, while each PDCCH monitoring interval may include a respective set of PDCCH monitoring occasions. As shown, each of the LP-WUS monitoring intervals may be non-overlapping in time with each of the PDCCH monitoring intervals. Further, a WUS monitoring interval immediately prior in time to a PDCCH monitoring interval may be associated with that PDCCH monitoring interval. For example, the first WUS monitoring interval 920 may be associated with the first PDCCH monitoring interval 930.

In this case, after DCI 910 is received by main receiver 906, LP-WUR 908 transitions from an inactive mode to an active mode to begin monitoring for an LP-WUS in WUS monitoring occasions of the first WUS monitoring interval 920. If during the first WUS monitoring interval 920, LP-WUR 908 is unable to detect an LP-WUS, then LP-WUR returns to an inactive mode and main receiver 906 transitions to an active mode to begin monitoring for downlink data. In particular, main receiver 906 may monitor for one or more downlink transmissions in PDCCH monitoring occasions of the first PDCCH monitoring interval 930. In some aspects, main receiver 906 monitors for downlink transmissions in a search space set group associated with the first PDCCH monitoring interval 930.

If during the first PDCCH monitoring interval 930, main receiver 906 is unable to detect any downlink data, then main receiver 906 returns to an inactive mode and LP-WUR 908 transitions to an active mode to begin monitoring for an LP-WUS again. Transitioning between LP-WUS monitoring and PDCCH monitoring may continue until an LP-WUS or downlink data is detected. For example, in FIG. 9, a LP-WUS 912 may be detected during third WUS monitoring interval 924. Detection of LP-WUS 912 may trigger main receiver to begin monitoring for downlink data. After downlink data is detected by main receiver 906, LP-WUR may not return to monitoring for LP-WUS in a next WUS monitoring interval. When monitoring for downlink data, main receiver 906 may be configured to monitor a less sparse search space set group than a search space set group when an LP-WUS is not detected. Monitoring for downlink data consumes more power than monitoring for LP-WUS; thus, main receiver 906 may monitor sparsely (e.g., monitor a less sparse search space set group) to help save power.

In some cases, when monitoring for downlink data in a PDDCH monitoring interval, main receiver 906 may receive a PDCCH skipping indication indicating to skip monitoring one or more PDCCH monitoring occasions in the PDCCH monitoring interval. For example, if a PDDCH monitoring interval includes PDDCH monitoring occasions 1-4 and the PDCCH skipping indication is detected in PDCCH monitoring occasion 3, then main receiver 906 may skip monitoring PDCCH monitoring occasion 4. Further, LP-WUR 90 may transition to an active mode to again begin monitoring for LP-WUS based on main receiver 906 receiving the PDCCH skipping indication. This helps to consume power, given monitoring for downlink data consumes more power than monitoring for LP-WUS.

In some aspects, instead of an LP-WUS being a signal transmitted when data is determined to be sent to a UE, the LP-WUS may be an always-transmitted signal. In particular, the LP-WUS may be transmitted irrespective of whether or not data is intended to be transmitted to a UE in an upcoming or current DRX ON duration. However, the LP-WUS may include an indication for a main receiver to wake up or stay asleep. For example, the LP-WUS may include an indication for the main receiver to wake up when data is expected to be transmitted to the main receiver in an upcoming or current DRX ON duration. Alternatively, the LP-WUS may include an indication for the main receiver to stay asleep when data is not expected to be transmitted to the main receiver in the upcoming or current DRX ON duration.

### Example Operations

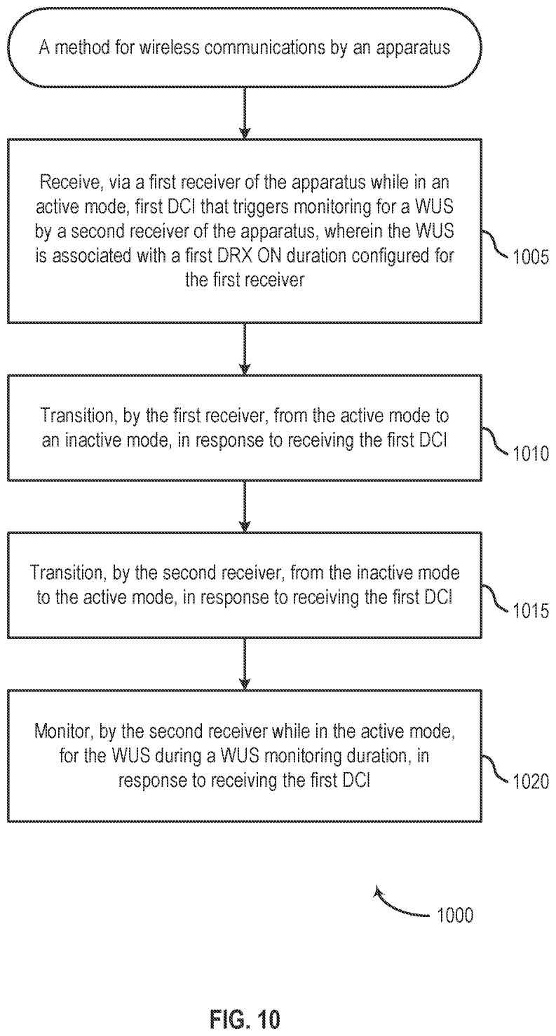

FIG. 10 shows a method 1000 for wireless communications by an apparatus, such as UE 104 of FIGS. 1 and 3.

Method 1000 begins at step 1005 with receiving, via a first receiver of the apparatus while in an active mode, first DCI that triggers monitoring for a WUS by a second receiver of the apparatus, wherein the WUS is associated with a first DRX ON duration configured for the first receiver.

Method 1000 then proceeds to step 1010 with transitioning, by the first receiver, from the active mode to an inactive mode, in response to receiving the first DCI.

Method 1000 then proceeds to step 1015 with transitioning, by the second receiver, from the inactive mode to the active mode, in response to receiving the first DCI.

Method 1000 then proceeds to step 1020 with monitoring, by the second receiver while in the active mode, for the WUS during a WUS monitoring duration, in response to receiving the first DCI.

In certain aspects, the first receiver comprises a main receiver of the apparatus, and the second receiver comprises a LP-WUR of the apparatus.

In certain aspects, a format of the first DCI comprises a DCI 2_6 format.

In certain aspects, method 1000 further includes detecting, by the second receiver, the WUS.

In certain aspects, method 1000 further includes transitioning, by the second receiver, from the active mode to the inactive mode.

In certain aspects, method 1000 further includes transitioning, by the first receiver, from the inactive mode to the active mode.

In certain aspects, method 1000 further includes monitoring, by the first receiver while in the active mode, for one or more transmissions during the first DRX ON duration.

In certain aspects, method 1000 further includes receiving the first DCI in a first occasion associated with a first search space set group.

In certain aspects, method 1000 further includes monitoring, by the first receiver while in the active mode, for the one or more transmissions in the first search space set group.

In certain aspects, the WUS comprises a plurality of bits; at least one of the plurality of bits indicates a search space set group; and the method further comprises monitoring, by the first receiver while in the active mode, for the one or more transmissions in the search space set group indicated in the WUS.

In certain aspects, method 1000 further includes starting the WUS monitoring duration and begin monitoring, by the second receiver, for the WUS at an offset from: a last symbol of the received first DCI, a predefined slot, or a reference point in time.

In certain aspects, method 1000 further includes receiving an indication of the offset via RRC signaling.

In certain aspects, method 1000 further includes receiving an indication of the offset via a MAC-CE.

In certain aspects, method 1000 further includes receiving an indication of the offset via a second DCI.

In certain aspects, the first DCI comprises an indication of the offset.

In certain aspects, method 1000 further includes receiving an indication of the WUS monitoring duration for the second receiver to monitor for the WUS.

In certain aspects, method 1000 further includes determining, by the second receiver, that the WUS was not detected during the WUS monitoring duration. In certain aspects, based on the determination that the WUS was not detected during the WUS monitoring duration, method 1000 further includes: transitioning, by the second receiver, from the active mode to the inactive mode; transitioning, by the first receiver, from the inactive mode to the active mode; and monitoring, by the first receiver while in the active mode, for one or more transmissions during the first DRX ON duration.

In certain aspects, method 1000 further includes monitoring, by the first receiver while in the active mode, for the one or more transmissions in a default search space set group configured for the apparatus.

In certain aspects, the first DCI comprises an indication of a search space set group that the first receiver is to monitor for the one or more transmissions; and the method further comprises monitoring, by the first receiver while in the active mode, for the one or more transmissions in the search space set group indicated in the first DCI.

In certain aspects, method 1000 further includes receiving, via a second DCI, an indication of a search space set group that the first receiver is to monitor for the one or more transmissions.

In certain aspects, method 1000 further includes monitoring, by the first receiver while in the active mode, for the one or more transmissions in the search space set group indicated in the second DCI.

In certain aspects, method 1000 further includes determining, by the second receiver, that the second receiver will be unable to detect the WUS prior to a termination of the WUS monitoring duration. In certain aspects, based on the determination that the second receiver will be unable to detect the WUS prior to a termination of the WUS monitoring duration, method 1000 further includes: transitioning, by the second receiver, from the active mode to the inactive mode; transitioning, by the first receiver, from the inactive mode to the active mode; and monitoring, by the first receiver while in the active mode, for one or more transmissions during the first DRX ON duration.

In certain aspects, method 1000 further includes receiving the first DCI in a first occasion associated with a first WUS monitoring configuration.

In certain aspects, method 1000 further includes monitoring, by the second receiver while in the active mode, for the WUS according to the first WUS monitoring configuration.

In certain aspects, the first WUS monitoring configuration comprises at least one of: an indication of a start time for the WUS monitoring duration when the second receiver is to begin monitoring for the WUS, an indication of an amount of time for the WUS monitoring duration, an interval between WUS monitoring occasions for monitoring for the WUS.

In certain aspects, method 1000 further includes determining, by the second receiver, that the WUS was not detected during the WUS monitoring duration. In certain aspects, based on the determination that the WUS was not detected during the WUS monitoring duration, method 1000 further includes: transitioning, by the second receiver, from the active mode to the inactive mode; transitioning, by the first receiver, from the inactive mode to the active mode; and transmitting, by the first receiver while in the active mode, feedback indicating an inability of the apparatus to detect the WUS during the WUS monitoring duration.

In certain aspects, the WUS monitoring duration includes two or more first noncontiguous intervals, each respective first noncontiguous interval is associated with a respective set of WUS monitoring occasions, the first DRX ON duration is separated into two or more second noncontiguous intervals, each respective second noncontiguous interval is associated with a respective set of PDCCH monitoring occasions, each of the first noncontiguous intervals are non-overlapping in time with each of the second noncontiguous intervals, and each respective first noncontiguous interval is associated with one of the second noncontiguous intervals later in time than the respective first noncontiguous interval.

In certain aspects, method 1000 further includes determining, by the second receiver, that the WUS was not detected in the set of WUS monitoring occasions associated with a first-in-time first noncontiguous interval of the two or more first noncontiguous intervals. In certain aspects, based on the determination, method 1000 further includes: transitioning, by the second receiver, from the active mode to the inactive mode; transitioning, by the first receiver, from the inactive mode to the active mode; and monitoring, by the first receiver while in the active mode, for one or more transmissions in the set of PDCCH occasions associated with a first-in-time second noncontiguous interval of the two or more second noncontiguous intervals.

In certain aspects, the first-in-time second noncontiguous interval is associated with a search space set group; and the method further comprises monitoring, by the first receiver while in the active mode, for one or more transmissions in the search space set group associated with the first-in-time second noncontiguous interval.

In certain aspects, method 1000 further includes determining, by the first receiver, that the one or more transmissions were not received in the set of PDCCH occasions associated with the first-in-time second noncontiguous interval. In certain aspects, based on the determination, method 1000 further includes: transitioning, by the first receiver, from the active mode to the inactive mode; transitioning, by the second receiver, from the inactive mode to the active mode; and monitoring, by the second receiver, for the WUS in a set of WUS occasions associated with a second-in-time first noncontiguous interval of the two or more first noncontiguous intervals.

In certain aspects, method 1000 further includes monitoring, by the second receiver while in the active mode, for the WUS in the set of WUS monitoring occasions associated with a first-in-time first noncontiguous interval of the two or more first noncontiguous intervals.

In certain aspects, method 1000 further includes detecting, by the second receiver, the WUS.

In certain aspects, method 1000 further includes transitioning, by the second receiver, from the active mode to the inactive mode.

In certain aspects, method 1000 further includes transitioning, by the first receiver, from the inactive mode to the active mode.

In certain aspects, method 1000 further includes monitoring, by the first receiver while in the active mode, for one or more transmissions in less than all PDCCH occasions in the set of PDCCH occasions associated with a first-in-time second noncontiguous interval of the two or more second noncontiguous intervals.

In certain aspects, method 1000 further includes detecting, by the first receiver, the one or more transmissions, the one or more transmissions indicating to, at least, skip monitoring remaining PDCCH occasions in the set of PDCCH occasions.

In certain aspects, method 1000 further includes transitioning, by the second receiver, from the inactive mode to the active mode.

In certain aspects, method 1000 further includes monitoring, by the second receiver, for a next WUS.

In certain aspects, method 1000 further includes detecting, by the second receiver, the WUS, the WUS comprising an indication for the first receiver to wake up or not to wake up.

In certain aspects, when the WUS comprises the indication for the first receiver to wake up, the method 1000 includes: transitioning, by the second receiver, from the active mode to the inactive mode; transitioning, by the first receiver, from the inactive mode to the active mode; and monitoring, by the first receiver while in the active mode, for one or more transmissions during the first DRX ON duration; and when the WUS comprises the indication for the first receiver not to wake up: transitioning, by the second receiver, from the active mode to the inactive mode.

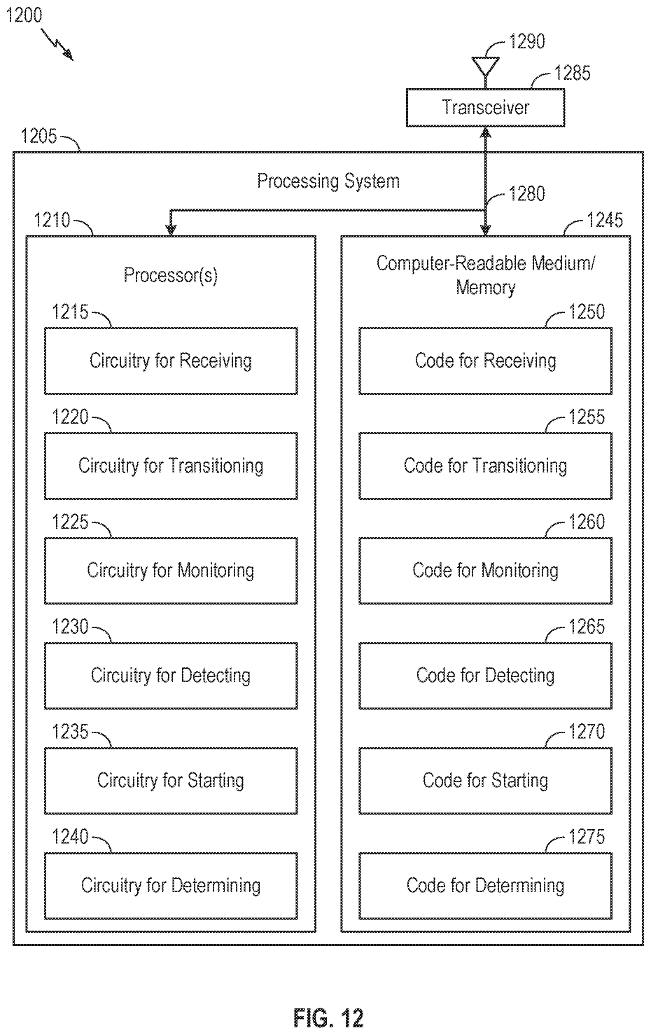

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

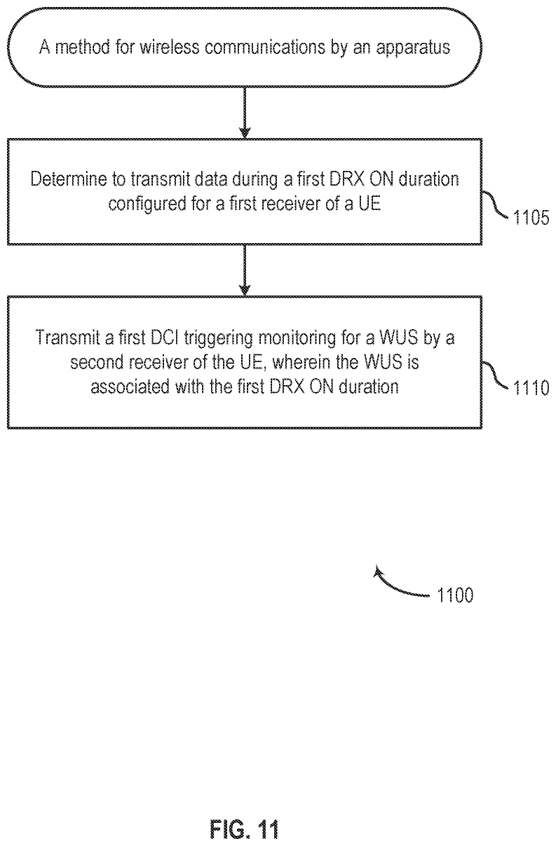

FIG. 11 shows a method 1100 for wireless communications by an apparatus, such as BS 102 of FIGS. 1 and 3, or a disaggregated base station as discussed with respect to FIG. 2.

Method 1100 begins at step 1105 with determining to transmit data during a first DRX ON duration configured for a first receiver of a UE.

Method 1100 then proceeds to step 1110 with transmitting a first DCI triggering monitoring for a WUS by a second receiver of the UE, wherein the WUS is associated with the first DRX ON duration.

In certain aspects, the first receiver comprises a main receiver of the apparatus, and the second receiver comprises a LP-WUR of the apparatus.

In certain aspects, a format of the first DCI comprises a DCI 2_6 format.

In certain aspects, method 1100 further includes transmitting the first DCI in a first occasion associated with a first search space set group.

In certain aspects, method 1100 further includes transmitting the WUS to the UE.

In certain aspects, the WUS comprises an indication for the first receiver of the UE to wake up or not to wake up.

In certain aspects, the WUS comprises a plurality of bits, at least one of the plurality of bits indicates a search space set group.

In certain aspects, method 1100 further includes receiving feedback indicating an inability of the second receiver of the user equipment to detect the WUS.

In certain aspects, method 1100 further includes performing one or more actions to adjust signaling with the second receiver.

In certain aspects, method 1100 further includes transmitting, to the UE, an indication of an offset from: a last symbol of the transmitted first DCI, a predefined slot, or a reference point in time to start a WUS monitoring duration and begin monitoring for the WUS.

In certain aspects, method 1100 further includes receiving the indication of the offset via RRC signaling.

In certain aspects, method 1100 further includes receiving the indication of the offset via a MAC-CE.

In certain aspects, method 1100 further includes receiving the indication of the offset via a second DCI.

In certain aspects, the first DCI comprises the indication of the offset.

In certain aspects, method 1100 further includes transmitting an indication of the WUS monitoring duration for monitoring for the WUS.

In certain aspects, method 1100 further includes determining the WUS monitoring duration based on a predicted amount of jitter.

In certain aspects, the first DCI comprises an indication of a search space set group that the UE is to monitor for one or more transmissions during the first DRX ON duration.

In certain aspects, method 1100 further includes transmitting, via a second DCI, an indication of a search space set group that the UE is to monitor for one or more transmissions during the first DRX ON duration.

In certain aspects, method 1100 further includes transmitting the first DCI in a first occasion associated with a first WUS monitoring configuration.

In certain aspects, the first WUS monitoring configuration comprises at least one of: an indication of a start time for a WUS monitoring duration when the UE is to begin monitoring for the WUS, an indication of an amount of time for the WUS monitoring duration, an interval between WUS monitoring occasions for monitoring for the WUS.

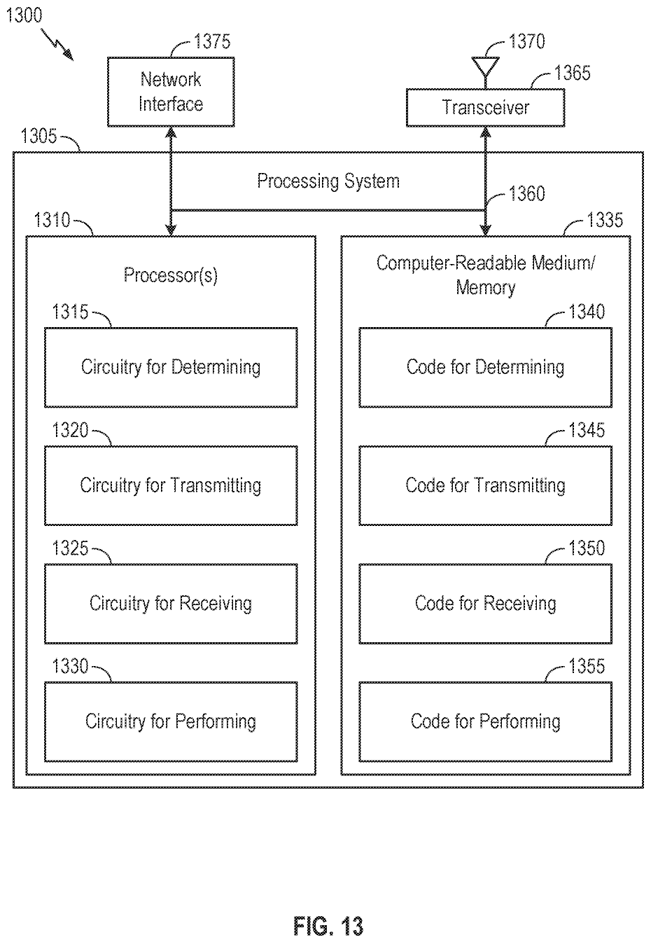

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1285 (e.g., a transmitter and/or a receiver). The transceiver 1285 is configured to transmit and receive signals for the communications device 1200 via an antenna 1290, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1245 via a bus 1280. In certain aspects, the computer-readable medium/memory 1245 is configured to store instructions (e.g., computer-executable code) that when executed by the one or more processors 1210, enable and cause the one or more processors 1210 to perform the method 1000 described with respect to FIG. 10, or any aspect related to it, including any additional steps or sub-steps described in relation to FIG. 10. Note that reference to a processor performing a function of communications device 1200 may include one or more processors performing that function of communications device 1200, such as in a distributed fashion.

In the depicted example, computer-readable medium/memory 1245 stores code for receiving 1250, code for transitioning 1255, code for monitoring 1260, code for detecting 1265, code for starting 1270, and code for determining 1275. Processing of the code 1250-1275 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1245, including circuitry for receiving 1215, circuitry for transitioning 1220, circuitry for monitoring 1225, circuitry for detecting 1230, circuitry for starting 1235, and circuitry for determining 1240. Processing with circuitry 1215-1240 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1285 and/or antenna 1290 of the communications device 1200 in FIG. 12, and/or one or more processors 1210 of the communications device 1200 in FIG. 12. Means for communicating, receiving or obtaining may include the transceivers 354, antenna(s) 352, receive processor 358, and/or controller/processor 380 of the UE 104 illustrated in FIG. 3, transceiver 1285 and/or antenna 1290 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, enable and cause the one or more processors 1310 to perform the method 1100 described with respect to FIG. 11, or any aspect related to it, including any additional steps or sub-steps described in relation to FIG. 11. Note that reference to a processor of communications device 1300 performing a function may include one or more processors of communications device 1300 performing that function, such as in a distributed fashion.

In the depicted example, the computer-readable medium/memory 1335 stores code for determining 1340, code for transmitting 1345, code for receiving 1350, and code for performing 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for determining 1315, circuitry for transmitting 1320, circuitry for receiving 1325, and circuitry for performing 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1365 and/or antenna 1370 of the communications device 1300 in FIG. 13, and/or one or more processors 1310 of the communications device 1300 in FIG. 13. Means for communicating, receiving or obtaining may include the transceivers 332, antenna(s) 334, receive processor 338, and/or controller/processor 340 of the BS 102 illustrated in FIG. 3, transceiver 1365 and/or antenna 1370 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by an apparatus comprising: receiving, via a first receiver of the apparatus while in an active mode, first DCI that triggers monitoring for a WUS by a second receiver of the apparatus, wherein the WUS is associated with a first DRX ON duration configured for the first receiver; transitioning, by the first receiver, from the active mode to an inactive mode, in response to receiving the first DCI; transitioning, by the second receiver, from the inactive mode to the active mode, in response to receiving the first DCI; and monitoring, by the second receiver while in the active mode, for the WUS during a WUS monitoring duration, in response to receiving the first DCI.

Clause 2: The method of Clause 1, wherein: the first receiver comprises a main receiver of the apparatus, and the second receiver comprises a LP-WUR of the apparatus.

Clause 3: The method of any one of Clauses 1-2, wherein a format of the first DCI comprises a DCI 2_6 format.

Clause 4: The method of any one of Clauses 1-3, further comprising: detecting, by the second receiver, the WUS; transitioning, by the second receiver, from the active mode to the inactive mode; transitioning, by the first receiver, from the inactive mode to the active mode; and monitoring, by the first receiver while in the active mode, for one or more transmissions during the first DRX ON duration.

Clause 5: The method of Clause 4, further comprising: receiving the first DCI in a first occasion associated with a first search space set group; and monitoring, by the first receiver while in the active mode, for the one or more transmissions in the first search space set group.

Clause 6: The method of Clause 4, wherein: the WUS comprises a plurality of bits; at least one of the plurality of bits indicates a search space set group; and the method further comprises monitoring, by the first receiver while in the active mode, for the one or more transmissions in the search space set group indicated in the WUS.

Clause 7: The method of any one of Clauses 1-6, further comprising: starting the WUS monitoring duration and begin monitoring, by the second receiver, for the WUS at an offset from: a last symbol of the received first DCI, a predefined slot, or a reference point in time.

Clause 8: The method of Clause 7, further comprising receiving an indication of the offset via RRC signaling.

Clause 9: The method of Clause 7, further comprising receiving an indication of the offset via a MAC-CE.

Clause 10: The method of Clause 7, further comprising receiving an indication of the offset via a second DCI.

Clause 11: The method of Clause 7, wherein the first DCI comprises an indication of the offset.

Clause 12: The method of any one of Clauses 1-11, further comprising receiving an indication of the WUS monitoring duration for the second receiver to monitor for the WUS.

Clause 13: The method of any one of Clauses 1-12, further comprising: determining, by the second receiver, that the WUS was not detected during the WUS monitoring duration; and based on the determination that the WUS was not detected during the WUS monitoring duration: transitioning, by the second receiver, from the active mode to the inactive mode, transitioning, by the first receiver, from the inactive mode to the active mode, and monitoring, by the first receiver while in the active mode, for one or more transmissions during the first DRX ON duration.

Clause 14: The method of Clause 13, further comprising monitoring, by the first receiver while in the active mode, for the one or more transmissions in a default search space set group configured for the apparatus.

Clause 15: The method of Clause 13, wherein: the first DCI comprises an indication of a search space set group that the first receiver is to monitor for the one or more transmissions; and the method further comprises monitoring, by the first receiver while in the active mode, for the one or more transmissions in the search space set group indicated in the first DCI.

Clause 16: The method of Clause 13, further comprising: receiving, via a second DCI, an indication of a search space set group that the first receiver is to monitor for the one or more transmissions; and monitoring, by the first receiver while in the active mode, for the one or more transmissions in the search space set group indicated in the second DCI.

Clause 17: The method of any one of Clauses 1-16, further comprising: determining, by the second receiver, that the second receiver will be unable to detect the WUS prior to a termination of the WUS monitoring duration; and based on the determination that the second receiver will be unable to detect the WUS prior to a termination of the WUS monitoring duration: transitioning, by the second receiver, from the active mode to the inactive mode, transitioning, by the first receiver, from the inactive mode to the active mode, and monitoring, by the first receiver while in the active mode, for one or more transmissions during the first DRX ON duration.

Clause 18: The method of any one of Clauses 1-17, further comprising: receiving the first DCI in a first occasion associated with a first WUS monitoring configuration; and monitoring, by the second receiver while in the active mode, for the WUS according to the first WUS monitoring configuration.

Clause 19: The method of Clause 18, wherein the first WUS monitoring configuration comprises at least one of: an indication of a start time for the WUS monitoring duration when the second receiver is to begin monitoring for the WUS, an indication of an amount of time for the WUS monitoring duration, an interval between WUS monitoring occasions for monitoring for the WUS.

Clause 20: The method of any one of Clauses 1-19, further comprising: determining, by the second receiver, that the WUS was not detected during the WUS monitoring duration; and based on the determination that the WUS was not detected during the WUS monitoring duration: transitioning, by the second receiver, from the active mode to the inactive mode, transitioning, by the first receiver, from the inactive mode to the active mode, and transmitting, by the first receiver while in the active mode, feedback indicating an inability of the apparatus to detect the WUS during the WUS monitoring duration.

Clause 21: The method of any one of Clauses 1-20, wherein: the WUS monitoring duration includes two or more first noncontiguous intervals, each respective first noncontiguous interval is associated with a respective set of WUS monitoring occasions, the first DRX ON duration is separated into two or more second noncontiguous intervals, each respective second noncontiguous interval is associated with a respective set of PDCCH monitoring occasions, each of the first noncontiguous intervals are non-overlapping in time with each of the second noncontiguous intervals, and each respective first noncontiguous interval is associated with one of the second noncontiguous intervals later in time than the respective first noncontiguous interval.

Clause 22: The method of Clause 21, further comprising: determining, by the second receiver, that the WUS was not detected in the set of WUS monitoring occasions associated with a first-in-time first noncontiguous interval of the two or more first noncontiguous intervals; and based on the determination: transitioning, by the second receiver, from the active mode to the inactive mode, transitioning, by the first receiver, from the inactive mode to the active mode, and monitoring, by the first receiver while in the active mode, for one or more transmissions in the set of PDCCH occasions associated with a first-in-time second noncontiguous interval of the two or more second noncontiguous intervals.

Clause 23: The method of Clause 22, wherein: the first-in-time second noncontiguous interval is associated with a search space set group; and the method further comprises monitoring, by the first receiver while in the active mode, for one or more transmissions in the search space set group associated with the first-in-time second noncontiguous interval.

Clause 24: The method of Clause 22, further comprising: determining, by the first receiver, that the one or more transmissions were not received in the set of PDCCH occasions associated with the first-in-time second noncontiguous interval; and based on the determination: transitioning, by the first receiver, from the active mode to the inactive mode, transitioning, by the second receiver, from the inactive mode to the active mode, and monitoring, by the second receiver, for the WUS in a set of WUS occasions associated with a second-in-time first noncontiguous interval of the two or more first noncontiguous intervals.

Clause 25: The method of Clause 21, further comprising: monitoring, by the second receiver while in the active mode, for the WUS in the set of WUS monitoring occasions associated with a first-in-time first noncontiguous interval of the two or more first noncontiguous intervals; detecting, by the second receiver, the WUS; transitioning, by the second receiver, from the active mode to the inactive mode; transitioning, by the first receiver, from the inactive mode to the active mode; monitoring, by the first receiver while in the active mode, for one or more transmissions in less than all PDCCH occasions in the set of PDCCH occasions associated with a first-in-time second noncontiguous interval of the two or more second noncontiguous intervals; detecting, by the first receiver, the one or more transmissions, the one or more transmissions indicating to, at least, skip monitoring remaining PDCCH occasions in the set of PDCCH occasions; transitioning, by the second receiver, from the inactive mode to the active mode; and monitoring, by the second receiver, for a next WUS.

Clause 26: The method of any one of Clauses 1-25, further comprising detecting, by the second receiver, the WUS, the WUS comprising an indication for the first receiver to wake up or not to wake up.

Clause 27: The method of Clause 26, wherein, when the WUS comprises the indication for the first receiver to wake up, the method further comprises: transitioning, by the second receiver, from the active mode to the inactive mode; transitioning, by the first receiver, from the inactive mode to the active mode; and monitoring, by the first receiver while in the active mode, for one or more transmissions during the first DRX ON duration; and when the WUS comprises the indication for the first receiver not to wake up: transitioning, by the second receiver, from the active mode to the inactive mode.

Clause 28: A method for wireless communications by an apparatus comprising: determining to transmit data during a first DRX ON duration configured for a first receiver of a UE; and transmitting a first DCI triggering monitoring for a WUS by a second receiver of the UE, wherein the WUS is associated with the first DRX ON duration.

Clause 29: The method of Clause 28, wherein: the first receiver comprises a main receiver of the apparatus, and the second receiver comprises a LP-WUR of the apparatus.

Clause 30: The method of any one of Clauses 28-29, wherein a format of the first DCI comprises a DCI 2_6 format.

Clause 31: The method of any one of Clauses 28-30, further comprising transmitting the first DCI in a first occasion associated with a first search space set group.

Clause 32: The method of any one of Clauses 28-31, further comprising transmitting the WUS to the UE.

Clause 33: The method of Clause 32, wherein the WUS comprises an indication for the first receiver of the UE to wake up or not to wake up.

Clause 34: The method of Clause 32, wherein: the WUS comprises a plurality of bits, at least one of the plurality of bits indicates a search space set group.

Clause 35: The method of Clause 32, further comprising: receiving feedback indicating an inability of the second receiver of the user equipment to detect the WUS; and performing one or more actions to adjust signaling with the second receiver.

Clause 36: The method of any one of Clauses 28-35, further comprising transmitting, to the UE, an indication of an offset from: a last symbol of the transmitted first DCI, a predefined slot, or a reference point in time to start a WUS monitoring duration and begin monitoring for the WUS.

Clause 37: The method of Clause 36, further comprising receiving the indication of the offset via RRC signaling.

Clause 38: The method of Clause 36, further comprising receiving the indication of the offset via a MAC-CE.

Clause 39: The method of Clause 36, further comprising receiving the indication of the offset via a second DCI.

Clause 40: The method of Clause 36, wherein the first DCI comprises the indication of the offset.

Clause 41: The method of Clause 36, further comprising transmitting an indication of the WUS monitoring duration for monitoring for the WUS.

Clause 42: The method of Clause 41, further comprising determining the WUS monitoring duration based on a predicted amount of jitter.

Clause 43: The method of any one of Clauses 28-42, wherein the first DCI comprises an indication of a search space set group that the UE is to monitor for one or more transmissions during the first DRX ON duration.

Clause 44: The method of any one of Clauses 28-43, further comprising transmitting, via a second DCI, an indication of a search space set group that the UE is to monitor for one or more transmissions during the first DRX ON duration.

Clause 45: The method of any one of Clauses 28-44, further comprising transmitting the first DCI in a first occasion associated with a first WUS monitoring configuration.

Clause 46: The method of Clause 45, wherein the first WUS monitoring configuration comprises at least one of: an indication of a start time for a WUS monitoring duration when the UE is to begin monitoring for the WUS, an indication of an amount of time for the WUS monitoring duration, an interval between WUS monitoring occasions for monitoring for the WUS.

Clause 47: One or more apparatuses, comprising: one or more memories comprising executable instructions; and one or more processors configured to execute the executable instructions and cause the one or more apparatuses to perform a method in accordance with any one of clauses 1-46.

Clause 48: One or more apparatuses, comprising means for performing a method in accordance with any one of clauses 1-46.

Clause 49: One or more non-transitory computer-readable media comprising executable instructions that, when executed by one or more processors of one or more apparatuses, cause the one or more apparatuses to perform a method in accordance with any one of clauses 1-46.

Clause 50: One or more computer program products embodied on one or more computer-readable storage media comprising code for performing a method in accordance with any one of clauses 1-46.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories comprising processor-executable instructions; and
one or more processors configured to execute the processor-executable instructions and cause the apparatus to:
receive, via a first receiver of the apparatus while in an active mode, first downlink control information (DCI) that triggers monitoring for a wake-up signal (WUS) by a second receiver of the apparatus, wherein the WUS is associated with a first discontinuous reception (DRX) ON duration configured for the first receiver;
in response to receiving the first DCI:
transition, by the first receiver, from the active mode to an inactive mode;
transition, by the second receiver, from the inactive mode to the active mode; and
monitor, by the second receiver while in the active mode, for the WUS during a WUS monitoring duration.

2. The apparatus of claim 1, wherein:
the first receiver comprises a main receiver of the apparatus, and
the second receiver comprises a low power wake up receiver (LP-WUR) of the apparatus.

3. The apparatus of claim 1, wherein a format of the first DCI comprises a DCI 2_6 format.

4. The apparatus of claim 1, wherein the one or more processors are configured to execute the processor-executable instructions and cause the apparatus to:
detect, by the second receiver, the WUS;
transition, by the second receiver, from the active mode to the inactive mode;
transition, by the first receiver, from the inactive mode to the active mode; and
monitor, by the first receiver while in the active mode, for one or more transmissions during the first DRX ON duration.

5. The apparatus of claim 4, wherein the one or more processors are configured to execute the processor-executable instructions and cause the apparatus to:
receive the first DCI in a first occasion associated with a first search space set group; and
monitor, by the first receiver while in the active mode, for the one or more transmissions in the first search space set group.

6. The apparatus of claim 4, wherein:
the WUS comprises a plurality of bits,
at least one of the plurality of bits indicates a search space set group, and
the one or more processors are configured to execute the processor-executable instructions and cause the apparatus to monitor, by the first receiver while in the active mode, for the one or more transmissions in the search space set group indicated in the WUS.

7. The apparatus of claim 1, wherein the one or more processors are configured to execute the processor-executable instructions and cause the apparatus to:
start the WUS monitoring duration and begin monitoring, by the second receiver, for the WUS at an offset from:
a last symbol of the received first DCI,
a predefined slot, or
a reference point in time.

8. The apparatus of claim 7, wherein the one or more processors are configured to execute the processor-executable instructions and cause the apparatus to receive an indication of the offset via:
radio resource control (RRC) signaling;
a medium access control control element (MAC-CE); or
a second DCI.

9. The apparatus of claim 7, wherein the first DCI comprises an indication of the offset.

10. The apparatus of claim 1, wherein the one or more processors are configured to execute the processor-executable instructions and cause the apparatus to receive an indication of the WUS monitoring duration for the second receiver to monitor for the WUS.

11. The apparatus of claim 1, wherein the one or more processors are configured to execute the processor-executable instructions and cause the apparatus to:
determine, by the second receiver, that the WUS was not detected during the WUS monitoring duration; and
based on the determination that the WUS was not detected during the WUS monitoring duration:
transition, by the second receiver, from the active mode to the inactive mode;
transition, by the first receiver, from the inactive mode to the active mode; and
monitor, by the first receiver while in the active mode, for one or more transmissions during the first DRX ON duration.

12. The apparatus of claim 11, wherein the one or more processors are configured to execute the processor-executable instructions and cause the apparatus to monitor, by the first receiver while in the active mode, for the one or more transmissions in a default search space set group configured for the apparatus.

13. The apparatus of claim 11, wherein:
the first DCI comprises an indication of a search space set group that the first receiver is to monitor for the one or more transmissions, and
the one or more processors are configured to execute the processor-executable instructions and cause the apparatus to monitor, by the first receiver while in the active mode, for the one or more transmissions in the search space set group indicated in the first DCI.

14. The apparatus of claim 11, wherein the one or more processors are configured to execute the processor-executable instructions and cause the apparatus to:
receive, via a second DCI, an indication of a search space set group that the first receiver is to monitor for the one or more transmissions; and
monitor, by the first receiver while in the active mode, for the one or more transmissions in the search space set group indicated in the second DCI.

15. The apparatus of claim 1, wherein the one or more processors are configured to execute the processor-executable instructions and cause the apparatus to:
determine, by the second receiver, that the second receiver will be unable to detect the WUS prior to a termination of the WUS monitoring duration; and
based on the determination that the second receiver will be unable to detect the WUS prior to a termination of the WUS monitoring duration:
transition, by the second receiver, from the active mode to the inactive mode;
transition, by the first receiver, from the inactive mode to the active mode; and
monitor, by the first receiver while in the active mode, for one or more transmissions during the first DRX ON duration.

16. The apparatus of claim 1, wherein the one or more processors are configured to execute the processor-executable instructions and cause the apparatus to:
receive the first DCI in a first occasion associated with a first WUS monitoring configuration; and
monitor, by the second receiver while in the active mode, for the WUS according to the first WUS monitoring configuration.

17. The apparatus of claim 16, wherein the first WUS monitoring configuration comprises at least one of:
an indication of a start time for the WUS monitoring duration when the second receiver is to begin monitoring for the WUS,
an indication of an amount of time for the WUS monitoring duration,
an interval between WUS monitoring occasions for monitoring for the WUS.

18. The apparatus of claim 1, wherein the one or more processors are configured to execute the processor-executable instructions and cause the apparatus to:
determine, by the second receiver, that the WUS was not detected during the WUS monitoring duration; and
based on the determination that the WUS was not detected during the WUS monitoring duration:
transition, by the second receiver, from the active mode to the inactive mode;
transition, by the first receiver, from the inactive mode to the active mode; and
transmit, by the first receiver while in the active mode, feedback indicating an inability of the apparatus to detect the WUS during the WUS monitoring duration.

19. The apparatus of claim 1, wherein:
the WUS monitoring duration includes two or more first noncontiguous intervals, each respective first noncontiguous interval is associated with a respective set of WUS monitoring occasions,
the first DRX ON duration is separated into two or more second noncontiguous intervals, each respective second noncontiguous interval is associated with a respective set of physical downlink control channel (PDCCH) monitoring occasions,
each of the first noncontiguous intervals are non-overlapping in time with each of the second noncontiguous intervals, and
each respective first noncontiguous interval is associated with one of the second noncontiguous intervals later in time than the respective first noncontiguous interval.

20. The apparatus of claim 19, wherein the one or more processors are configured to execute the processor-executable instructions and cause the apparatus to:
determine, by the second receiver, that the WUS was not detected in the set of WUS monitoring occasions associated with a first-in-time first noncontiguous interval of the two or more first noncontiguous intervals; and
based on the determination:
transition, by the second receiver, from the active mode to the inactive mode;
transition, by the first receiver, from the inactive mode to the active mode; and
monitor, by the first receiver while in the active mode, for one or more transmissions in the set of PDCCH occasions associated with a first-in-time second noncontiguous interval of the two or more second noncontiguous intervals.

21. The apparatus of claim 20, wherein:
the first-in-time second noncontiguous interval is associated with a search space set group, and
the one or more processors are configured to execute the processor-executable instructions and cause the apparatus to monitor, by the first receiver while in the active mode, for one or more transmissions in the search space set group associated with the first-in-time second noncontiguous interval.

22. The apparatus of claim 20, wherein the one or more processors are configured to execute the processor-executable instructions and cause the apparatus to:
determine, by the first receiver, that the one or more transmissions were not received in the set of PDCCH occasions associated with the first-in-time second noncontiguous interval; and
based on the determination:
transition, by the first receiver, from the active mode to the inactive mode;
transition, by the second receiver, from the inactive mode to the active mode; and
monitor, by the second receiver, for the WUS in a set of WUS occasions associated with a second-in-time first noncontiguous interval of the two or more first noncontiguous intervals.

23. The apparatus of claim 19, wherein the one or more processors are configured to execute the processor-executable instructions and cause the apparatus to:
monitor, by the second receiver while in the active mode, for the WUS in the set of WUS monitoring occasions associated with a first-in-time first noncontiguous interval of the two or more first noncontiguous intervals;
detect, by the second receiver, the WUS;
transition, by the second receiver, from the active mode to the inactive mode;
transition, by the first receiver, from the inactive mode to the active mode;
monitor, by the first receiver while in the active mode, for one or more transmissions in less than all PDCCH occasions in the set of PDCCH occasions associated with a first-in-time second noncontiguous interval of the two or more second noncontiguous intervals;
detect, by the first receiver, the one or more transmissions, the one or more transmissions indicating to, at least, skip monitoring remaining PDCCH occasions in the set of PDCCH occasions;
transition, by the second receiver, from the inactive mode to the active mode; and
monitor, by the second receiver, for a next WUS.

24. The apparatus of claim 1, wherein the one or more processors are configured to execute the processor-executable instructions and cause the apparatus to detect, by the second receiver, the WUS, the WUS comprising an indication for the first receiver to wake up or not to wake up.

25. An apparatus configured for wireless communications, comprising:
one or more memories comprising processor-executable instructions; and
one or more processors configured to execute the processor-executable instructions and cause the apparatus to:
determine to transmit data during a first discontinuous reception (DRX) ON duration configured for a first receiver of a user equipment (UE); and
transmit a first downlink control information (DCI) triggering monitoring for a wake-up signal (WUS) by a second receiver of the UE, wherein the WUS is associated with the first DRX ON duration.

26. The apparatus of claim 25, wherein the one or more processors are configured to execute the processor-executable instructions and cause the apparatus to transmit the WUS to the UE.

27. The apparatus of claim 26, wherein the one or more processors are configured to execute the processor-executable instructions and cause the apparatus to:
receive feedback indicating an inability of the second receiver of the user equipment to detect the WUS; and
perform one or more actions to adjust signaling with the second receiver.

28. The apparatus of claim 26, wherein the one or more processors are configured to execute the processor-executable instructions and cause the apparatus to:
determine a WUS monitoring duration for monitoring for the WUS based on a predicted amount of jitter; and
transmit, to the UE, an indication of the WUS monitoring duration.

29. A method for wireless communications by an apparatus, comprising:
receiving, via a first receiver of the apparatus while in an active mode, first downlink control information (DCI) that triggers monitoring for a wake-up signal (WUS) by a second receiver of the apparatus, wherein the WUS is associated with a first discontinuous reception (DRX) ON duration configured for the first receiver;
in response to receiving the first DCI:
transitioning, by the first receiver, from the active mode to an inactive mode;
transitioning, by the second receiver, from the inactive mode to the active mode; and
monitoring, by the second receiver while in the active mode, for the WUS during a WUS monitoring duration.

30. A method for wireless communications by an apparatus, comprising:
determining to transmit data during a first discontinuous reception (DRX) ON duration configured for a first receiver of a user equipment (UE); and
transmitting a first downlink control information (DCI) triggering monitoring for a wake-up signal (WUS) by a second receiver of the UE, wherein the WUS is associated with the first DRX ON duration.
